(19) United States
(12) Patent Application Publication
(10) Pub. No.: US 2020/0110840 A1
(43) Pub. Date: Apr. 9, 2020

(54) AUDIO CONTEXT ASSISTED TEXT SEARCH

(71) Applicant: Dell Products L. P., Round Rock, TX (US)

(72) Inventors: Someshwar Mukherjee, Bangalore (IN); James S. Watt, JR., Austin, TX (US)

(21) Appl. No.: 16/152,071

(22) Filed: Oct. 4, 2018

(51) Int. Cl. G06F 17/30; G10L 15/22; G10L 15/18

(52) U.S. Cl. CPC G06F 17/30758; G10L 15/1815; G10L 15/22

(57) ABSTRACT

In some examples, a search module executing on a computing device may determine that text input has been entered into a search entry field of a search engine. The module may retrieve audio data stored in a buffer. The audio data may be retrieved using an application programming interface of an operating system. The audio data may include audio captured by a microphone prior to the text input being entered. The module may send a search request that includes the text input and context data derived from the audio data to a search engine. The context data may comprise the audio data or additional text derived from the audio data. The context data may be included in metadata of the search request. The search engine may perform a search based on the text input and the context data and provide search results that are displayed in the browser.

### BACKGROUND OF THE INVENTION

### Field of the Invention

This invention relates generally to computing devices and, more particularly to using audio data captured prior to a text search being initiated to supplement the text search.

### Description of the Related Art

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When a user enters text into a search entry field of a search site on the Internet, the search terms may be fairly brief and may not be suited to identifying the search results that the user desires. Often, a user may have a conversation with one or more people prior to performing the search. For example, computer users who use their respective computing devices to play games may discuss the make, model, and configuration of their respective computing devices. After the discussion, one of the users may be interested in obtaining additional information about a particular computing device used by one of the other computer users and initiate a text search. However, the user may not obtain the desired results because the user may use too few words. For example, the user may forget the specific make, model, and/or configuration information that was discussed and use different words, frustrating the user.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some examples, an enhanced search module being executed by a computing device may determine that text input has been entered into a search entry field of a search site opened in a browser and retrieve audio data stored in a buffer. For example, the enhanced search module may retrieve the audio data by calling an application programming interface (API) of an operating system of the computing device. The buffer may be associated with a voice assistant application installed on the computing device and may be configured as a first-in-first-out (FIFO) buffer. The audio data may include between about 5 seconds to about 300 seconds of audio captured by a microphone connected to the computing device. The audio may be captured by the microphone prior to the text input being entered into the search entry field of the search site. The operations may include sending a search request to a search engine associated with the search site. The search request may include the text input and context data derived from the audio data. In some cases, the context data may comprise the audio data. For example, the audio data may be included in metadata associated with the search request. In other cases, the audio data may be converted, using a speech-to-text module, into additional text and the additional text may be included in the metadata associated with the search request. In still other cases, the audio data may be converted, using a speech-to-text module, into text, one or more words in the text may be identified as being included in a dictionary file stored in a memory of the computing device, and the one or more words may be included in the metadata of the search request. The search engine may scan the context data to determine one or more words associated with a context associated with the search request and to perform a search based on the text input and the one or more words. The operations may include receiving search results from the search engine and displaying at least a portion of the search results in the browser.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a computing device with an enhanced search module, according to some embodiments.

FIG. 2 is a flowchart of a process that includes sending a search request including text input and audio data, according to some embodiments.

FIG. 3 is a flowchart of a process that includes sending a search request including text input and additional text (e.g., converted from audio data), according to some embodiments.

FIG. 4 is a flowchart of a process that includes sending a search request including text input and one or more words in a dictionary, according to some embodiments.

FIG. 5 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein may augment a text-based search request using audio data captured prior to the search request being sent to a search engine. For example, an enhanced search application installed on a computing device may use a microphone connected to the computing device to monitor audio data being captured by the microphone. The audio data captured by the microphone may be placed in a buffer (or similar), such as a first-in first-out (FIFO) buffer, such that the buffer includes X seconds (where X>0) of audio data. The amount of audio data that the buffer can store may have a default setting that can be altered by a user. In some cases, the buffer may be associated with a voice assistant that is monitoring the audio data for a trigger word that can be used to instruct the voice assistant to perform one or more tasks. In such cases, the enhanced search application may use an application programming interface (API) of an operating system (OS) to access the audio data in the buffer.

When the enhanced search application detects that a user of the computing device has opened a browser and navigated the browser to a search site, the enhanced search application may copy the audio data in the buffer (e.g., audio data that has been captured up to that point in time) for further processing. In some cases, the enhanced search application may append the audio data to the text-based search request that is sent to the search engine. In other cases, the enhanced search application may use a speech-to-text module to convert the audio data to additional text and append the additional text to the text-based search request that is sent to the search engine. The search engine may use the audio data or additional text to provide context to the text-based search request and provide more relevant search results (as compared to if the audio data or additional text was not used). Thus, the context refers to a pre-determined length (e.g., X seconds, where X>0) of audio captured by a microphone connected to the computing device before the text-based search request is sent to the search engine.

For example, a computing device may include one or more processors and a non-transitory computer-readable storage media storing instructions that are executable by the one or more processors to perform various operations. For example, the operations may include determining that a search site has been opened in a browser, determining that text input has been entered into a search entry field of the search site, and retrieving audio data stored in a buffer. For example, retrieving the audio data stored in the buffer may include calling an application programming interface (API) of an operating system of the computing device to retrieve the audio data. The buffer may be associated with a voice assistant application installed on the computing device and may be configured as a first-in-first-out (FIFO) buffer. The audio data may include between about 5 seconds to about 300 seconds of audio captured by a microphone connected to the computing device. The audio may be captured by the microphone prior to the text input being entered into the search entry field of the search site. The operations may include sending a search request to a search engine associated with the search site. The search request may include the text input and context data derived from the audio data. In some cases, the context data may comprise the audio data. For example, the audio data may be included in metadata associated with the search request. In other cases, the audio data may be converted, using a speech-to-text module, into additional text and the additional text may be included in the metadata associated with the search request. In still other cases, the audio data may be converted, using a speech-to-text module, into text, one or more words in the text may be identified as being included in a dictionary file stored in a memory of the computing device, and the one or more words may be included in the metadata of the search request. The search engine may scan the context data to determine one or more words associated with a context associated with the search request and to perform a search based on the text input and the one or more words. The operations may include receiving search results from the search engine and displaying at least a portion of the search results in the browser.

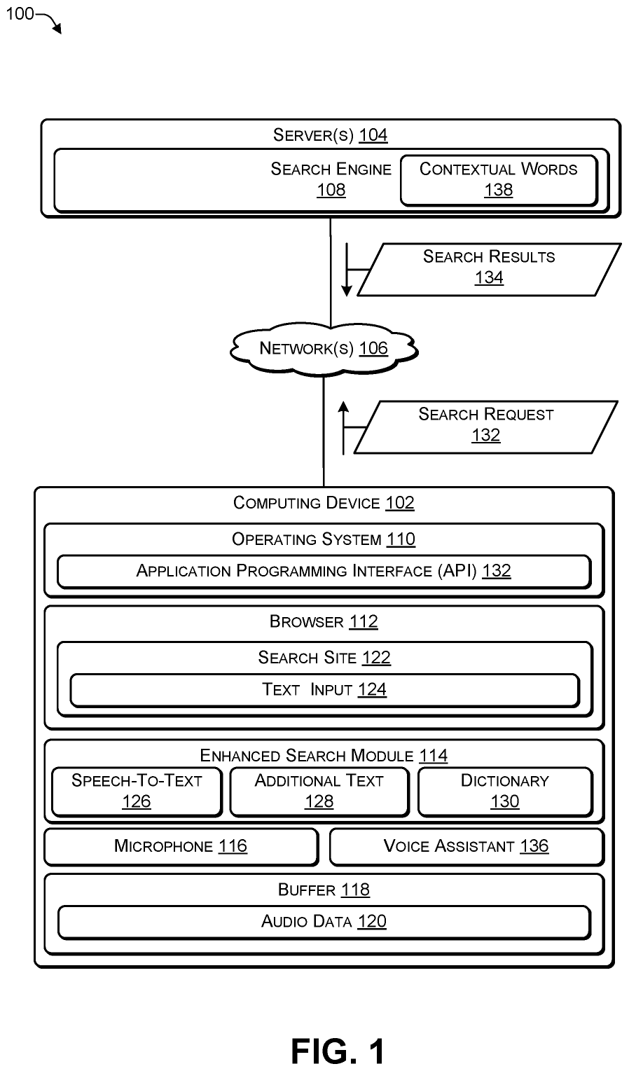

FIG. 1 is a block diagram of a system 100 that includes a computing device with an enhanced search module according to some embodiments. The system 100 includes a representative computing device 102 coupled to one or more servers 104 via one or more networks 106. The computing device 102 may be a mobile phone, a tablet, a laptop, a netbook, a desktop, or another type of computing device.

The server 104 may be hardware-based, cloud-based, or a combination of both. The server 104 may be part of the Internet (e.g., a network accessible to the public) or part of an intranet (e.g., a private network that is accessible to employees of a company but is inaccessible to others). The server 104 may include a search engine 108 that is capable of performing searches across multiple network-accessible sites.

The computing device 102 may include an operating system 110, a browser 112, an enhanced search module (e.g., software application) 114, a microphone 116, and a buffer 118. The microphone 116 may be integrated into the computing device 102 or the microphone 116 may be separate from and connected to the computing device 102. The buffer 118 may be a portion of a memory of the computing device 102 that is used to store audio data 120 received from the microphone 116. The buffer 118 may have a particular size and may use a mechanism, such as, for example, a first-in first-out (FIFO) mechanism, to store the audio data 120. For example, the buffer 118 may be capable of storing up to X seconds (X>0) of the audio data 120. The audio data 120 may be uncompressed digital data, such as a .wav file or the audio data 120 may be compressed as a .mp3, .mp4, or another type of compressed audio format. For example, the buffer 118 may be capable of storing from between several seconds to several minutes of the audio data 120. In some cases, a user of the computing device 102 may specify a size of the buffer 118.

In some cases, the buffer 118 may be associated with a voice assistant 136 while in other cases, the buffer 118 may be associated with the enhanced search module 114. For example, the voice assistant 136 may monitor the audio data 120 for a trigger word that is used prior to instruct the voice assistant to perform one or more tasks. The microphone 116 may be turned on (e.g., by the voice assistant 136 or by the enhanced search module 114) when the computing device 102 is booted up. After the microphone 116 is turned on, the microphone 116 may be constantly listening, e.g., continually capturing the audio data 120 and placing the audio data 120 in the buffer 118, with newly captured audio displacing the oldest captured audio in the buffer 118.

The enhanced search module 114 may monitor the browser 112. If the enhanced search module 114 determines that the browser 112 has been opened to a search site 122 and a user of the computing device 102 is providing text input 124 into a search field of the search site 122, then the enhanced search module 114 may retrieve the current contents (e.g., the audio data 120) of the buffer 118. In some cases (e.g., when the buffer 118 is associated with another application, such as the voice assistant 136), the enhanced search module 114 may request the audio data 120 in the buffer 118 using an application programming interface (API) 132 of the operating system 110. In other cases (e.g., when the buffer 118 is associated with the enhanced search module 114), the enhanced search module 114 may retrieve the audio data 120 from the buffer 118. After obtaining the audio data 120, the enhanced search module 114 may include the audio data 120 with the text input 124 in a search request 132 that is sent to the search engine 108. For example, the enhanced search module 114 may include the audio data 120 in metadata of the search request 132.

The search engine 108 may receive the search request 132 that includes the text input 124 and the audio data 120. The search engine 108 may scan the audio data 120 (e.g., included in metadata of the search request 132) for contextual words 138 (e.g., words that are contextually related to the text input 124) and perform a search based on the text input 124 and the contextual words 138. By performing a search using the text input 124 and the contextual words 138, the search engine 108 may provide search results 134 that are more relevant (e.g., compared to performing a search using just the text input 124).

In some cases, the search engine 108 may be incapable of processing the audio data 120. For example, the search engine 108 may be on an intranet and may not have the full features of an Internet-based search engine. In such cases, the enhanced search module 114 may obtain the audio data 120 and use a speech-to-text module 126 to convert the audio data 120 into additional text 128. The enhanced search module 114 may send the additional text 128 (e.g., instead of the audio data 120) with the text input 124 in the search request 132 to the search engine 108. For example, the enhanced search module 114 may include the additional text 128 in metadata of the search request 132. In some cases, the enhanced search module 114 may obtain the audio data 120 and use the speech-to-text module 126 to obtain the additional text 128. The enhanced search module may determine whether the additional text 128 includes one or more words included in a dictionary 130. If the additional text 128 includes one or more words from the dictionary 130, the enhanced search module 114 may send the one or more words along with the text input 124 in the search request 132. The search engine 108 may receive the search request 132 that includes the text input 124 and the additional text 128. The search engine 108 may scan the additional text 128 (e.g., included in metadata of the search request 132) for contextual words 138 (e.g., words that are contextually related to the text input 124) and perform a search based on the text input 124 and the contextual words 138. By performing a search using the text input 124 and the contextual words 138, the search engine 108 may provide search results 134 that are more relevant (e.g., compared to performing a search using just the text input 124).

Thus, an enhanced search module may be installed on a computing device to enhance search requests by including contextual data in a search request. For example, the enhanced search module may use a microphone of the computing device to continually capture and buffer audio data. The enhanced search module may monitor a browser (e.g., internet browser) and determine when the browser has navigated to a search site. When the enhanced search module determines that text input is being provided in an input field of the search engine, the enhanced search module may obtain the audio data from the buffer. The enhanced search module may include the audio data with the text input in a search request sent to the search engine. In some cases, the enhanced search module may convert the audio data (e.g., using a speech-to-text or similar module) to create additional text and send the additional text with the text input to the search engine. In this way, the text input entered into the input field of the search engine may be supplemented with contextual information to provide more relevant search results (e.g., as compared to performing a search using the text input without the audio data).

As an example of how the enhanced search module may be used, a user may be browsing on a computing device when a commercial for a product is played in the vicinity of the user. For example, the user may be a passenger in a vehicle in which a radio is playing or the user may be at home watching television or listening to the radio. The television or radio may play a commercial for a product, such as a particular type of laptop. For example, the commercial may audibly include the words “high definition video” when describing a gaming laptop, “enterprise security” when describing a laptop designed for enterprise customers, or “small and light” when describing an ultrabook. The user may open a browser on the computing device and input the text “laptop computer” in the text input field of an internet search site to perform a search. The words in the commercial may be captured by a microphone of the computing device and included in context data included (e.g., as metadata) in the search request sent to the search engine. The search engine may narrow the search and provide more accurate search results by using the audio data in addition to the text to perform a search. For example, when the words “high definition video” are present in the context data for a text search for “laptop computer,” the results may be narrowed to include gaming laptops (e.g., Dell® Alienware). When the words “enterprise security” are present in the context data for a text search for “laptop computer,” the results may be narrowed to include enterprise laptops (e.g., Dell® Latitude). When the words “small and light” are present in the context data for a text search for “laptop computer,” the results may be narrowed to include ultrabooks (e.g., Dell® XPS).

As another example of how the enhanced search module may be used, two (or more) users may be discussing the benefits and drawbacks of two laptops, e.g., a first laptop made by a first manufacturer and a second laptop made by a second manufacturer. One of the users opens a computing device and initiates a search for a laptop. The audio data captured in the buffer may include the names of the two manufacturers. The search request may include the text input “laptop” and may include the audio data with the names of the two manufacturers. The search results may include links to sites (e.g., articles and blog posts) showing a comparison of the two products being discussed. The search results may be narrowed to include laptops made by the two manufacturers and may exclude laptops made by other manufacturers.

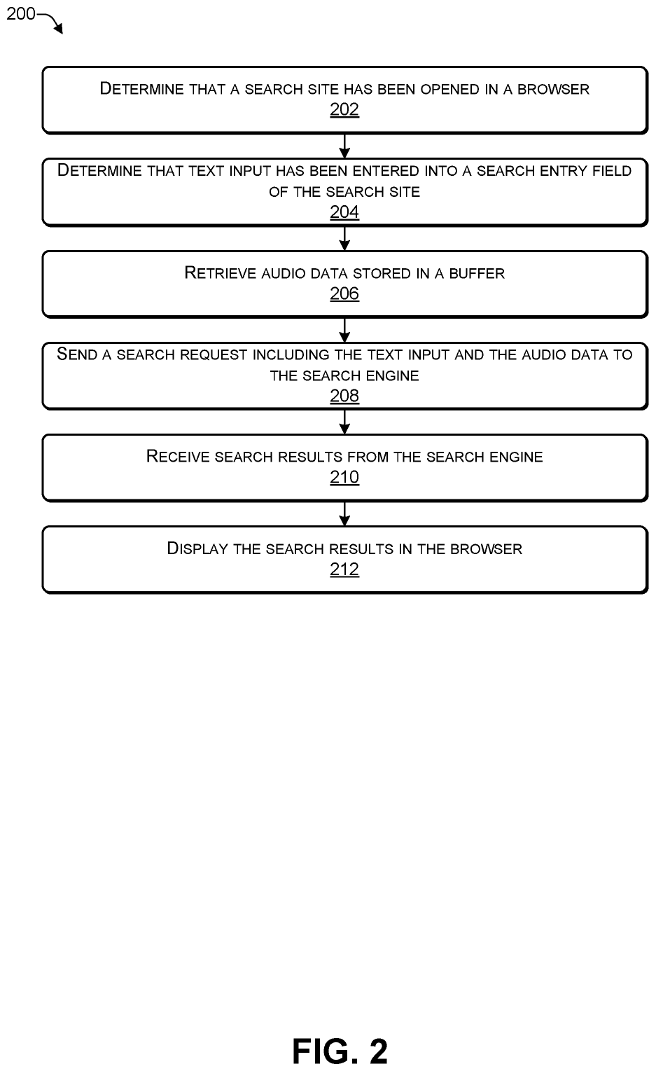

In the flow diagram of FIGS. 2, 3, and 4, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 200, 300, and 400, are described with reference to FIG. 1, as described above, although other models, frameworks, systems and environments may be used to implement these processes.

FIG. 2 is a flowchart of a process 200 that includes sending a search request including text input and audio data, according to some embodiments. The process 200 may be performed by the enhanced search module 114 of FIG. 1.

At 202, a determination may be made that a search site has been opened in a browser. At 204, a determination may be made that text input has been entered into a search entry field of the search site. At 206, audio data stored in a buffer may be retrieved. For example, in FIG. 1, the enhanced search module 114 may monitor the browser 112 and determine that a user has navigated the browser 112 to the search site 122 and is providing the text input 124. In response, the enhanced search module 114 may obtain the audio data 120 from the buffer 118. The audio data 120 may include audio gathered by a microphone for a predetermined amount of time prior to the text input being entered into the search entry field of the search site. In some cases, the buffer 118 may be associated with the enhanced search module 114 while in other cases the buffer 118 may be associated with the voice assistant 136. If the buffer 118 is associated with the voice assistant 136, then the enhanced search module 114 may use the API 132 of the operating system 110 to retrieve the audio data 120 from the buffer 118. If the buffer 118 is associated with the enhanced search module 114, then the enhanced search module 114 may directly retrieve the audio data 120 from the buffer 118.

At 208, a search request including the text input and the audio data may be sent to the search engine. At 210, search results maybe received from the search engine. At 212, the search results may be displayed in the browser. For example, in FIG. 1, after obtaining the audio data 120, the enhanced search module 114 may send the search request 132 that includes the text input 124 and the audio data 120 (e.g., included as metadata in the search request 132) to the search engine 108. The search engine 108 may perform a search using the text input 124 and one or more words found in the audio data 120. The one or more words may provide a content for the text input 124, enabling the search results 134 to be narrower (e.g., focused) as compared to doing a search using just the text input 124.

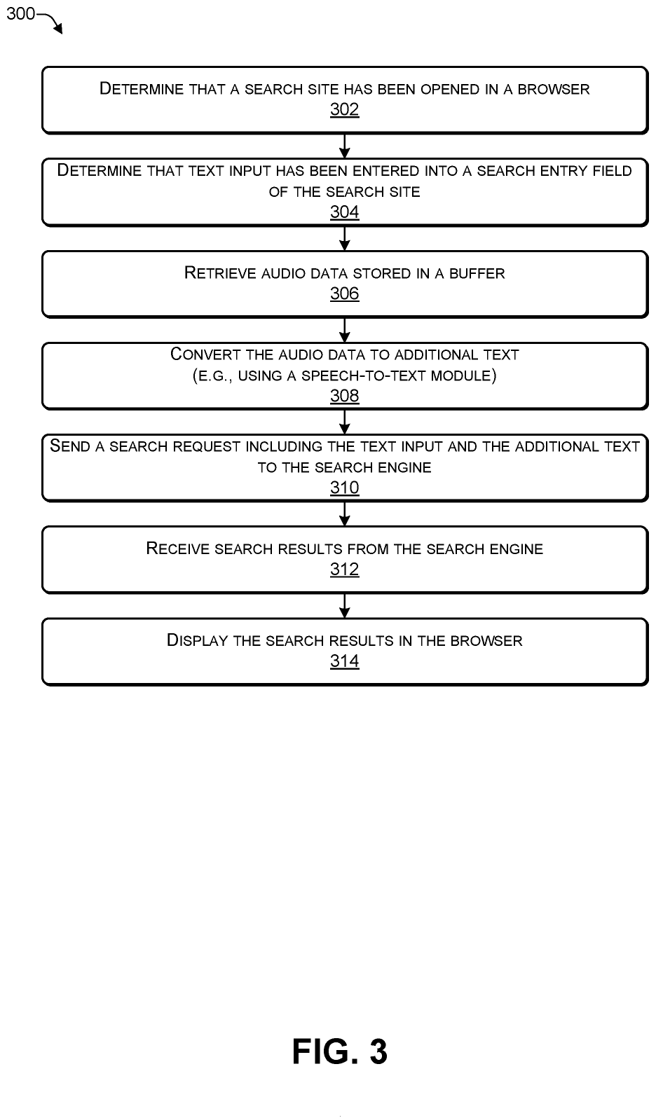

FIG. 3 is a flowchart of a process 300 that includes sending a search request including text input and additional text (e.g., converted from audio data), according to some embodiments. The process 300 may be performed by the enhanced search module 114 of FIG. 1.

At 302, a determination may be made that a search site has been opened in a browser. At 304, a determination may be made that text input has been entered into a search entry field of the search site. At 306, audio data stored in a buffer may be retrieved. For example, in FIG. 1, the enhanced search module 114 may monitor the browser 112 and determine that a user has navigated the browser 112 to the search site 122 and is providing the text input 124. In response, the enhanced search module 114 may obtain the audio data 120 from the buffer 118. The audio data 120 may include audio gathered by a microphone for a predetermined amount of time prior to the text input being entered into the search entry field of the search site. In some cases, the buffer 118 may be associated with the enhanced search module 114 while in other cases the buffer 118 may be associated with the voice assistant 136. If the buffer 118 is associated with the voice assistant 136, then the enhanced search module 114 may use the API 132 of the operating system 110 to retrieve the audio data 120 from the buffer 118. If the buffer 118 is associated with the enhanced search module 114, then the enhanced search module 114 may directly retrieve the audio data 120 from the buffer 118.

At 308, the audio data may be converted to additional text. At 310, a search request including the text input and the additional text may be sent to the search engine. At 312, search results maybe received from the search engine. At 314, the search results may be displayed in the browser. For example, in FIG. 1, after obtaining the audio data 120, the enhanced search module 114 may use the speech-to-text module 126 to convert at least a portion of the audio data 120 to the additional text 128. The enhanced search module 114 may send the search request 132 that includes the text input 124 and the additional text 128 (e.g., included as metadata in the search request 132) to the search engine 108. The search engine 108 may perform a search using the text input 124 and one or more words found in the additional text 128. The one or more words may provide a content for the text input 124, enabling the search results 134 to be narrower (e.g., focused) as compared to doing a search using just the text input 124.

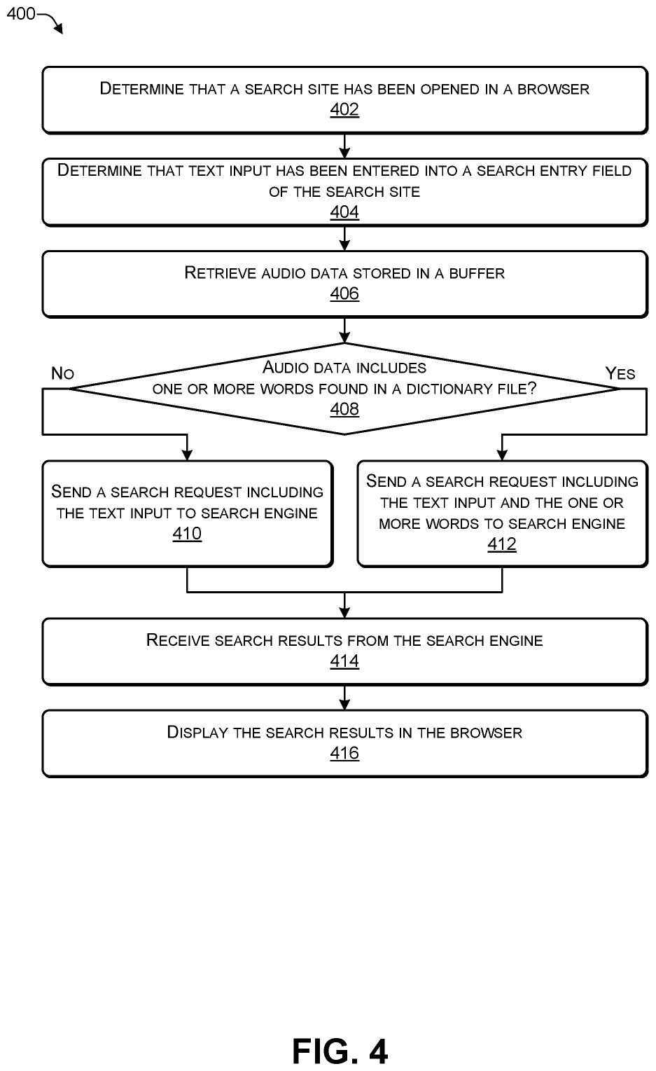

FIG. 4 is a flowchart of a process 400 that includes sending a search request including text input and one or more words in a dictionary, according to some embodiments. The process 400 may be performed by the enhanced search module 114 of FIG. 1.

At 402, a determination may be made that a search site has been opened in a browser. At 404, a determination may be made that text input has been entered into a search entry field of the search site. At 406, audio data stored in a buffer may be retrieved. For example, in FIG. 1, the enhanced search module 114 may monitor the browser 112 and determine that a user has navigated the browser 112 to the search site 122 and is providing the text input 124. In response, the enhanced search module 114 may obtain the audio data 120 from the buffer 118. The audio data 120 may include audio gathered by a microphone for a predetermined amount of time prior to the text input being entered into the search entry field of the search site. In some cases, the buffer 118 may be associated with the enhanced search module 114 while in other cases the buffer 118 may be associated with the voice assistant 136. If the buffer 118 is associated with the voice assistant 136, then the enhanced search module 114 may use the API 132 of the operating system 110 to retrieve the audio data 120 from the buffer 118. If the buffer 118 is associated with the enhanced search module 114, then the enhanced search module 114 may directly retrieve the audio data 120 from the buffer 118.

At 408, a determination may be made whether the audio data includes one or more words found in a dictionary file. If a determination is made, at 408, that the audio data does not include any of the words in the dictionary file, then the process may proceed to 410, where the search request that includes the text input is sent to the search engine. If a determination is made, at 408, that the audio data includes one or more of the words found in the dictionary file, the process may proceed to 412, where the search request (that includes the text input and the one or more words found in the dictionary) may be sent to the search engine. For example, in FIG. 1, after obtaining the audio data 120, the enhanced search module 114 may determine if one or more words in the audio data 120 are found in the dictionary 130. If the enhanced search module 114 determines that the audio data 120 does not include any of the words in the dictionary 130, then the search request 132 that includes the text input 124 may be sent to the search engine 108. If the enhanced search module 114 determines that the audio data 120 includes one or more of the words in the dictionary 130, then the search request 132 that includes the text input 124 and the one or more words (e.g., the additional text 128) found in the dictionary may be sent to the search engine 108.

At 414, search results maybe received from the search engine. At 416, the search results may be displayed in the browser. The search engine 108 may perform a search using the text input 124 and one or more words from the audio data 120 that were found in the dictionary 130. The one or more words may provide a content for the text input 124, enabling the search results 134 to be narrower (e.g., focused) as compared to doing a search using just the text input 124.

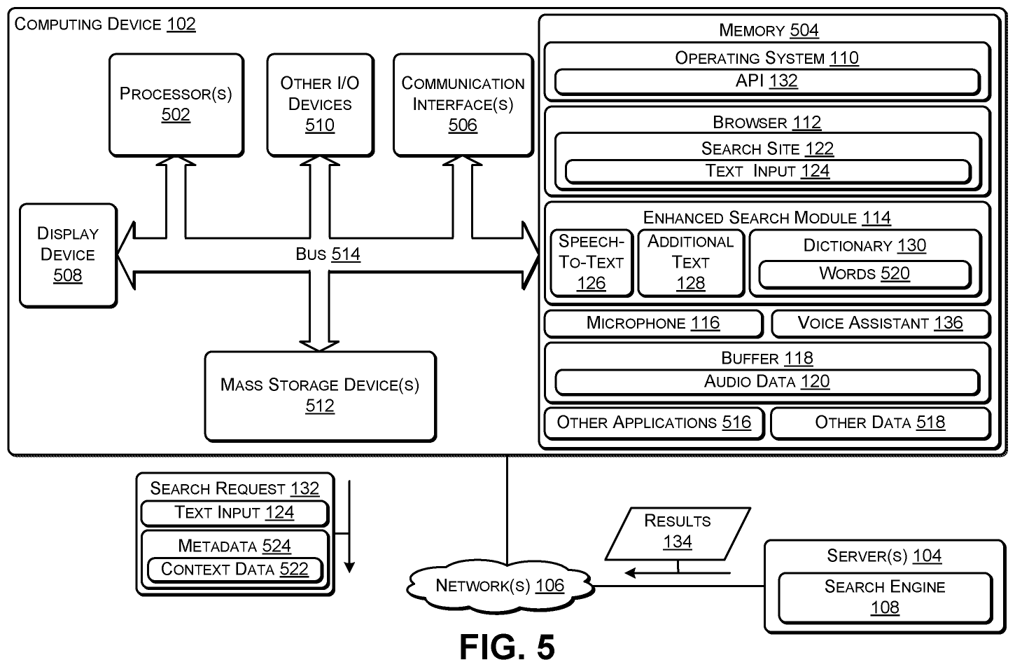

FIG. 5 illustrates an example configuration of the computing device 102 that can be used to implement the systems and techniques described herein. The computing device 500 may include one or more processors 502 (e.g., CPU, GPU, or the like), a memory 504, communication interfaces 506, a display device 508, other input/output (I/O) devices 510 (e.g., keyboard, trackball, and the like), and one or more mass storage devices 512 (e.g., disk drive, solid state disk drive, or the like), configured to communicate with each other, such as via one or more system buses 514 or other suitable connections. While a single system bus 514 is illustrated for ease of understanding, it should be understood that the system buses 514 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 502 are one or more hardware devices that may include a single processing unit or a number of processing units, all of which may include single or multiple computing units or multiple cores. The processors 502 may include a graphics processing unit (GPU) that is integrated into the CPU or the GPU may be a separate processor device from the CPU. The processors 502 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 502 may be configured to fetch and execute computer-readable instructions stored in the memory 504, mass storage devices 512, or other computer-readable media.

Memory 504 and mass storage devices 512 are examples of computer storage media (e.g., memory storage devices) for storing instructions that can be executed by the processors 502 to perform the various functions described herein. For example, memory 504 may include both volatile memory and non-volatile memory (e.g., RAM, ROM, or the like) devices. Further, mass storage devices 512 may include hard disk drives, solid-state drives, removable media, including external and removable drives, memory cards, flash memory, floppy disks, optical disks (e.g., CD, DVD), a storage array, a network attached storage, a storage area network, or the like. Both memory 504 and mass storage devices 512 may be collectively referred to as memory or computer storage media herein and may be any type of non-transitory media capable of storing computer-readable, processor-executable program instructions as computer program code that can be executed by the processors 502 as a particular machine configured for carrying out the operations and functions described in the implementations herein.

The computing device 500 may include one or more communication interfaces 506 for exchanging data via the network 106. The communication interfaces 506 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 506 can also provide communication with external storage, such as a storage array, network attached storage, storage area network, cloud storage, or the like.

The display device 508 may be used for displaying content (e.g., information and images) to users. Other I/O devices 510 may be devices that receive various inputs from a user and provide various outputs to the user, and may include a keyboard, a touchpad, a mouse, a printer, audio input/output devices, and so forth.

The computer storage media, such as memory 116 and mass storage devices 512, may be used to store software and data. For example, the computer storage media may be used to store the operating system 110 (with the API 132), the browser 112 (that can be navigated to the search site 122), the enhanced search module 114, the microphone 116, the voice assistant 136, the buffer 118 (in which the audio data 120 is stored), other software applications 516, and other data 518.

Thus, the enhanced search module 114, when installed on the computing device 102, may enhance the search request 132 by including contextual data 522 in metadata 524 of the search request 132. For example, the enhanced search module 114 may use the microphone 116 to continually capture and buffer the audio data 120. The enhanced search module 114 may monitor the 112 browser (e.g., internet browser) and determine when the browser 112 has navigated to the search site 122. When the enhanced search module 114 determines that the text input 124 is being provided in an input field of the search site 122, the enhanced search module 114 may obtain the audio data 120 from the buffer 118 (e.g., via the API 132). The enhanced search module 114 may include the audio data 120 (e.g., as the context data 522) with the text input 124 in the search request 132 sent to the search engine 108. In some cases, the enhanced search module 114 may convert the audio data 120 (e.g., using the speech-to-text 126 or similar module) to create the additional text 128 and send the additional text 128 as the context data 522 with the text input 124 to the search engine 108. In other cases, the enhanced search module 114 may determine if the audio data 120 includes one or more words 520 found in the dictionary 130 and the one or more words 520 as the context data 522 with the text input 124 to the search engine 108. In this way, the text input 124 sent to the search engine 108 may be augmented with the contextual information (e.g., the context data 522) to provide more relevant search results 134 (e.g., as compared to performing a search using only the text input 124).

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
determining, by one or more processors of a computing device, that a search site has been opened in a browser;
determining, by the one or more processors, that text input has been entered into a search entry field of the search site;
retrieving, by the one or more processors, audio data stored in a buffer;
sending, by the one or more processors, a search request to a search engine associated with the search site, the search request comprising the text input and context data derived from the audio data;
receiving, by the one or more processors, search results from the search engine; and
displaying, by the one or more processors, the search results in the browser.

2. The method of claim 1, further comprising:
including the audio data in a metadata of the search request, wherein the context data comprises the audio data.

3. The method of claim 1, further comprising:
converting, using a speech-to-text module, the audio data into additional text; and
including the additional text in a metadata of the search request, wherein the context data comprises the additional text.

4. The method of claim 1, further comprising:
converting, using a speech-to-text converter, the audio data into text;
determining that one or more words in the text are included in a dictionary file stored in a memory of the computing device; and
including the one or more words in a metadata of the search request, wherein the context data comprises the one or more words.

5. The method of claim 1, wherein retrieving the audio data stored in the buffer comprises:
calling an application programming interface (API) of an operating system of the computing device to retrieve the audio data, the buffer associated with a voice assistant application installed on the computing device.

6. The method of claim 1, wherein:
the audio data comprises between about 5 seconds to about 300 seconds of audio captured, by a microphone connected to the computing device, prior to the text input being entered into the search entry field of the search site; and
the buffer comprises a first-in-first-out (FIFO) buffer.

7. The method of claim 1, wherein:
the search engine uses the context data to determine one or more words associated with a context associated with the search request; and
the search engine performs a search based on the text input and the one or more words.

8. A computing device comprising:
one or more processors; and
one or more non-transitory computer readable media storing instructions executable by the one or more processors to perform operations comprising:
determining that a search site has been opened in a browser;
determining that text input has been entered into a search entry field of the search site;
retrieving audio data stored in a buffer;
sending a search request to a search engine associated with the search site, the search request comprising the text input and context data derived from the audio data;
receiving search results from the search engine; and
displaying, by the one or more processors, the search results in the browser.

9. The computing device of claim 8, wherein the operations further comprise:
including the audio data in a metadata of the search request, wherein the context data comprises the audio data.

10. The computing device of claim 8, wherein the operations further comprise:
converting, using a speech-to-text module, the audio data into additional text; and
including the additional text in a metadata of the search request, wherein the context data comprises the additional text.

11. The computing device of claim 8, wherein the operations further comprise:
converting, using a speech-to-text converter, the audio data into text;
determining that one or more words in the text are included in a dictionary file stored in a memory of the computing device; and
including the one or more words in a metadata of the search request, wherein the context data comprises the one or more words.

12. The computing device of claim 8, wherein retrieving the audio data stored in the buffer comprises:
calling an application programming interface (API) of an operating system of the computing device to retrieve the audio data, the buffer associated with a voice assistant application installed on the computing device.

13. The computing device of claim 8, wherein:
the audio data comprises between about 5 seconds to about 300 seconds of audio captured, by a microphone connected to the computing device, prior to the text input being entered into the search entry field of the search site; and
the buffer is configured as a first-in-first-out (FIFO) buffer.

14. One or more non-transitory computer readable media storing instructions executable by one or more processors to perform operations comprising:
determining that a search site has been opened in a browser;
determining that text input has been entered into a search entry field of the search site;
retrieving audio data stored in a buffer;
sending a search request to a search engine associated with the search site, the search request comprising the text input and context data derived from the audio data;
receiving search results from the search engine; and
displaying, by the one or more processors, the search results in the browser.

15. The one or more non-transitory computer readable media of claim 14, wherein the operations further comprise:
including the audio data in a metadata of the search request, wherein the context data comprises the audio data.

16. The one or more non-transitory computer readable media of claim 14, wherein the operations further comprise:
converting, using a speech-to-text module, the audio data into additional text; and
including the additional text in a metadata of the search request, wherein the context data comprises the additional text.

17. The one or more non-transitory computer readable media of claim 14, wherein the operations further comprise:
converting, using a speech-to-text converter, the audio data into text;
determining that one or more words in the text are included in a dictionary file stored in a memory of the computing device; and
including the one or more words in a metadata of the search request, wherein the context data comprises the one or more words.

18. The one or more non-transitory computer readable media of claim 14, wherein retrieving the audio data stored in the buffer comprises:
calling an application programming interface (API) of an operating system of the computing device to retrieve the audio data, the buffer associated with a voice assistant application installed on the computing device.

19. The one or more non-transitory computer readable media of claim 14, wherein:
the audio data comprises between about 5 seconds to about 300 seconds of audio captured, by a microphone connected to the computing device, prior to the text input being entered into the search entry field of the search site; and
the buffer is configured as a first-in-first-out (FIFO) buffer.

20. The one or more non-transitory computer readable media of claim 14, wherein the operations further comprise:
the search engine scans the context data to determine one or more words associated with a context associated with the search request; and
the search engine performs a search based on the text input and the one or more words.
